(19) United States
(12) Patent Application Publication
(10) Pub. No.: US 2011/0059703 A1
(43) Pub. Date: Mar. 10, 2011

(54) USER EQUIPMENT-INITIATED PRECODING SUBSET RESTRICTION FOR COMMUNICATION SYSTEMS

(75) Inventors: Klaus Hugl, Helsinki (FI); Jaakko Eero Samuli Visuri, Helsinki (FI)

(73) Assignee: NOKIA CORPORATION, Espoo (FI)

(21) Appl. No.: 12/680,724

(22) PCT Filed: Sep. 26, 2008
(86) PCT No.: PCT/IB08/53945

§ 371 Date: Jul. 6, 2010

Related U.S. Application Data
(60) Provisional application No. 60/976,106, filed on Sep. 28, 2007.

(51) Int. Cl. H04W 88/02

(52) U.S. Cl. 455/73

(57) ABSTRACT

A communication system includes user equipment 460 and a base station 410. In one embodiment, the user equipment 460 includes a processor 472 with a code word subset instruction module 475 that generates a user equipment-specific code word subset instruction Ω_{UEI INST} compatible with the user equipment 460, and a transceiver 469 that transmits the user equipment-specific code word subset instruction Ω_{UEI INST}. The base station 410 includes a transceiver 435 that receives the user equipment-specific code word subset instruction Ω_{UEI INST}, and a processor 440 with a code word subset restriction module 445 that generates a user equipment-specific code word subset Ω_{UEI} as a function of the user equipment-specific code word subset instruction Ω_{UEI INST} for transmission to the user equipment 460. The processor 440 precodes user data for transmission to the user equipment 460 via an antenna array 420 with the user equipment-specific code word subset Ω_{UEI}.

This application claims the benefit of U.S. Provisional Application No. 60/976,106 entitled “UE-Initiated Precoding Subset Restriction for MIMO Networks,” filed on Sep. 28, 2007, which is incorporated herein by reference.

### TECHNICAL FIELD

The present invention relates, in general, to communications systems and, more particularly, to user equipment (“UE”)-initiated restriction of a precoding subset in a communication system.

### BACKGROUND

The third generation partnership project (“3GPP”) long term evolution (“LTE”) describes an ongoing effort across the industry to improve the universal mobile telecommunications system (“UMTS”) for mobile communications to cope with continuing new requirements and the growing base of users. The goals of this broadly based project include improving communication efficiency, lowering costs, improving services, making use of new spectrum opportunities, and achieving better integration with other open standards. The 3GPP LTE work project should result in new recommendations for standards for the UMTS.

Advancement of the access network to the core communication network is also a topic of interest within the 3GPP. The access network, referred to as the universal terrestrial radio access network (“UTRAN”), deals with the part of the communication network that generally consists of radio network controllers (“RNCs”), which control access to radio resources and the base stations/Node Bs or enhanced Node Bs (“eNode Bs”) lying between an interface (referred to as the “Iu”) of the RNCs with the core communication network and an interface (referred to as the “Uu”) of the UTRAN with user equipment (“UE”) or terminals. The core communication network is accessed through mobile switching centers (“MSCs”), cell broadcast centers (“CBCs”), general packet radio service (“GPRS”) support nodes (“SGSN”), and the like.

For the LTE, one of the targets is to achieve high peak data rates combined with high spectral efficiency. To obtain this, a number of features are considered, such as hybrid automatic repeat requests (“HARQ”), to keep the spectral efficiency high, and multiple-input, multiple-output (“MIMO”) transmission, mainly to reach high peak data rates, but also to improve the average communication system throughput. Two of the MIMO communication operation modes are the downlink (“DL”) single user (“SU”) and multi-user (“MU”) MIMO communication modes (also referred to as “SU-MIMO” and “MU-MIMO,” respectively), which may be based on precoded multi-stream transmission to single or multiple users.

Precoding in MIMO is typically related to multi-layer beamforming. In single-layer beamforming, the same signal is emitted from each of the transmit antennas with the appropriate phase and gain weighting in an attempt to maximize the signal power at a receiver. The benefits of beamforming are to increase the signal gain from constructive combining of multiple signals and to reduce multipath fading effects. When the receiver has multiple antennas, as is typically the case in MIMO communication systems, the transmit beamforming cannot simultaneously maximize the signal level at all of the receive antennas. Therefore, precoding is used to increase that signal level. Implementation of precoding generally requires knowledge of the channel state information (“CSI”) at the transmitter. This precoded multi-stream transmission, therefore, effectively boosts the user data rates. Precoding is typically based on codebooks known by the eNode B and UE as configured according to 3GPP TS 36.211 entitled “3rd Generation Partnership Project; Technical Specification Group Radio Access Network; Physical Channels and Modulation (Release 8),” V.1.2.0 (June 2007), V.2.0.0 (September 2007) and V.8.0.0 (September 2007) which are incorporated herein by reference.

The eNode B may restrict the code words that are currently available to UEs in the codebook through code word subset restriction. An eNode B may restrict the codebook for various reasons, including eNode B capabilities, physical antenna array geometry, and the like. Once the eNode B restricts the codebook, the UEs receiving this code word subset restriction are generally bound to use only the restricted subset of code words. The eNode Bs may restrict the codebook entries used for UE reporting and eNode B transmission independently for each transmission rank. The independent restriction is typically performed through higher level signaling. This means that the eNode Bs may restrict the code words to be used by the UE and the eNode Bs. Thus, the UE are restricted to calculating the UE feedback related to rank, precoding weight, and corresponding channel quality identifier (“CQI”) values based on the restricted codebook.

Even with code words restricted from the codebook, it may still be quite large. For example, in a system or device with four transmit antennas, the restricted codebook may employ up to 16 code words. This large-size codebook creates additional baseband calculation complexity for the UE in selecting the preferred rank and precoding weight. Depending on the UE or terminal class, the computational complexity may cause problems at the UE.

Accordingly, what is needed in the art is a system and method that provide precoding code word subset restrictions for communication systems that overcome the deficiencies in the prior art.

### SUMMARY

These and other problems are generally solved or circumvented, and technical advantages are generally achieved, by embodiments of the present invention, which include a user equipment-initiated restriction of a precoding subset in a communication system. In one embodiment, a communication system includes an apparatus (e.g., user equipment) having an antenna array. The user equipment includes a processor including a code word subset instruction module configured to generate a user equipment-specific code word subset instruction compatible with the user equipment. The user equipment also includes a transceiver configured to transmit the user equipment-specific code word subset instruction to a base station. The transceiver is further configured to receive a user equipment-specific code word subset as a function of the user equipment-specific code word subset instruction and user data precoded with the user equipment-specific code word subset via the antenna array from the base station. The processor of the user equipment is configured to decode the user data with the user equipment-specific code word subset.

In another aspect, the communication system includes an apparatus (e.g., a base station) having an antenna array. The base station includes a transceiver configured to receive a user equipment-specific code word subset instruction compatible with a user equipment via the antenna array. The base station also includes a processor including a code word subset restriction module configured to generate a user equipment-specific code word subset as a function of the user equipment-specific code word subset instruction for transmission to the user equipment. The processor of the base station is configured to precode user data for transmission to the user equipment via the antenna array with the user equipment-specific code word subset.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the invention, and the advantages thereof, reference is now made to the following descriptions taken in conjunction with the accompanying drawing, in which:

FIG. 1 illustrates a system level diagram of an embodiment of a communication system constructed according to the principles of the present invention;

FIG. 2 illustrates a block diagram of an embodiment of a computer system in accordance with the systems, subsystems and modules of the present invention;

FIG. 3 illustrates a set diagram illustrating an exemplary relationship between code word subsets in a communication system according to the principles of the present invention;

FIGS. 4 and 5 illustrate block diagrams of embodiments of communication systems constructed according to the principles of the present invention; and

FIG. 6 illustrates a flowchart demonstrating an exemplary method of operating a communication system in accordance with the principles of the present invention.

### DETAILED DESCRIPTION OF ILLUSTRATIVE EMBODIMENTS

The making and using of the presently presented advantageous embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. The present invention will be described with respect to exemplary embodiments in a specific context, namely, a LTE DL MIMO communication system. The invention may also be applied, however, to other types of communication systems, especially communication systems that employ MIMO functionality.

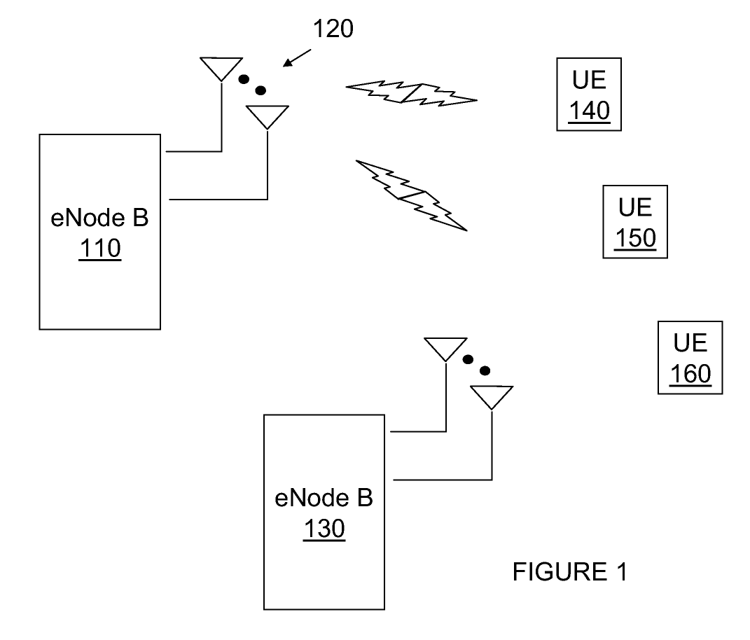

Referring initially to FIG. 1, illustrated is a system level diagram of an embodiment of a communication system constructed according to the principles of the present invention. In the illustrated embodiment, the communication system is employable with a MIMO communication network and includes a first eNode B 110 with an antenna array 120 in communication with a second eNode B 130 and a plurality of UE or terminals (referred to as a first UE 140, a second UE 150 and a third UE 160). Each of UEs 140, 150, 160 has transceiver(s) coupled to an antenna array. In operation of the communication system, a code word set or codebook is used in communications between the eNode Bs and UEs, such as the first eNode B 110 and the UEs 140, 150, 160. A codebook is defined for the particular communication network that includes each code word in the set for that communication network. Each of the eNode Bs may include a full codebook designed for the communication network (e.g., the MIMO communication network).

Instead of sending the entire codebook to the UEs, the first eNode B 110 may use subset restriction to create a subset of code words to transmit to a UE such as the first UE 140. The communication network, however, may include capabilities beyond the processing power of the first UE 140. Therefore, in order to keep calculation delays down, the first UE 140 can signal the first eNode B 110 to further restrict the code word subset to a new code word subset with even fewer code words that the first UE 140 is specifically programmed to work with in an efficient manner.

The UEs 140, 150, 160 may each signal a different number of code words for a subset, whether the subset is a small set of code words of the codebook, or whether the subset is the entire network codebook. The UEs 140, 150, 160 use the subset of code words for feedback to the first eNode B 110 regarding rank, precoding weight, CQI values, and the like. Based on this feedback, the first eNode B 110 may form the appropriate beams, attempting to maximize the signal transmissions between the first eNode B 110 and the UEs 140, 150, 160. Of course, analogous principles can also apply to the second eNode B 130 in communication with the UEs 140, 150, 160.

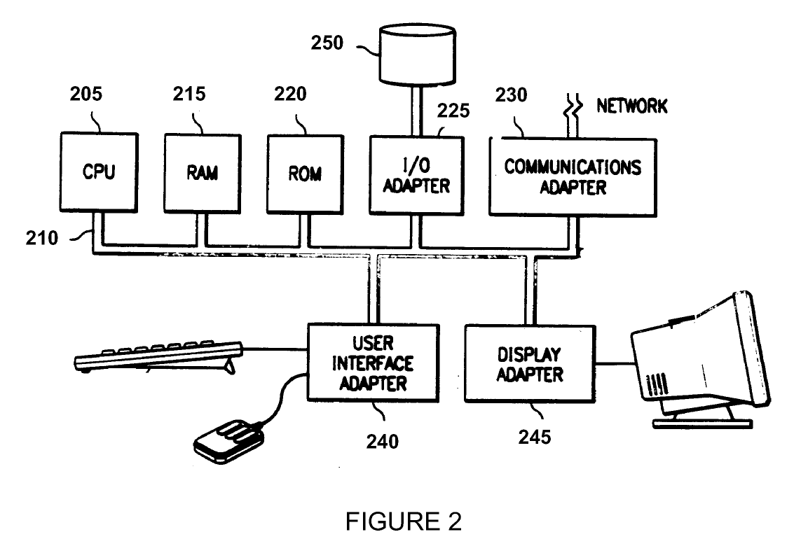

Before describing the system and method of the present invention in more detail, FIG. 2 illustrates a block diagram of an embodiment of a computer system in accordance with the systems, subsystems and modules of the present invention. The computer system is adapted to perform various functions such as storing and/or executing software associated with the systems, subsystems and modules as described herein. A central processing unit (“CPU”) 205 is coupled to a system bus 210. The CPU 205 may be any general purpose computer and embodiments of the present invention are not restricted by the architecture of the CPU 205. The bus 210 is coupled to a random access memory (“RAM”) 215, which may be a static random access memory (“SRAM”), dynamic random access memory (“DRAM”), or synchronous dynamic random access memory (“SDRAM”). A read only memory (“ROM”) 220 is also coupled to the bus 210, which may be programmable read only memory (“PROM”), erasable programmable read only memory (“EPROM”), or electrically erasable programmable read only memory (“EEPROM”). The RAM 215 and the ROM 220 hold user and system data and programs as are well known in the art.

The bus 210 is also coupled to input/output (“I/O”) adapter 225, communications adapter 230, user interface adapter 240, and display adapter 245. The I/O adapter 225 connects storage devices 250, such as one or more of a hard drive, a compact disc (“CD”) drive, a floppy disk drive, or a tape drive, to the computer system. The I/O adapter 225 is also connected to a printer (not shown), which would allow the system to print paper copies of information such as documents, photographs, articles, and the like. Note that the printer may be a printer (e.g., dot matrix, laser, and the like), a fax machine, scanner, or a copier machine.

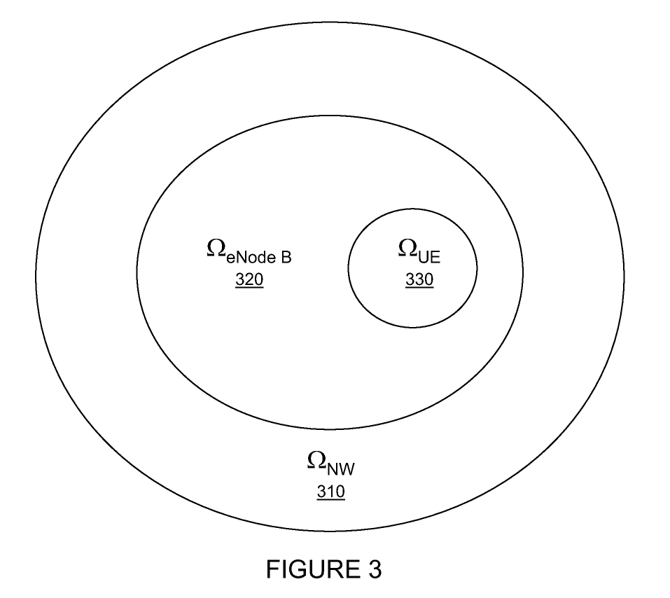

Turning now to FIG. 3, illustrated is a set diagram illustrating an exemplary relationship between code word subsets in a communication system employable with a MIMO communication network according to the principles of the present invention. The communication network codebook, which includes all code words for use in the communication system, is represented by Ω_{NW} 310. When restricting the codebook and forming a particular code word subset for use with any particular UE or transmission, a code word subset may be generated by the eNode B, which is represented by Ω_{eNode B} 320. The eNode B code word subset Ω_{eNode B} 320 may include the entire set of code words Ω_{NW} 310 or some subset of the code words of the codebook. The UE may then also assist in formation of a UE-specific code word subset represented by Ω_{uE} 330. As with the code word subset Ω_{eNode B} 320 created through subset restriction by the eNode B, the UE-specific code word subset Ω_{UE} 330 may also include all of the code words Ω_{NW} 310 of the communication network or up to any number of the code word subset Ω_{eNode B} 320 provided by the eNode B, depending on the capabilities of the particular UE. Thus, the eNode B code word subset Ω_{eNode B}⊂Ω_{NW} and the UE-specific code word subset Ω_{UE}⊂Ω_{eNode B}.

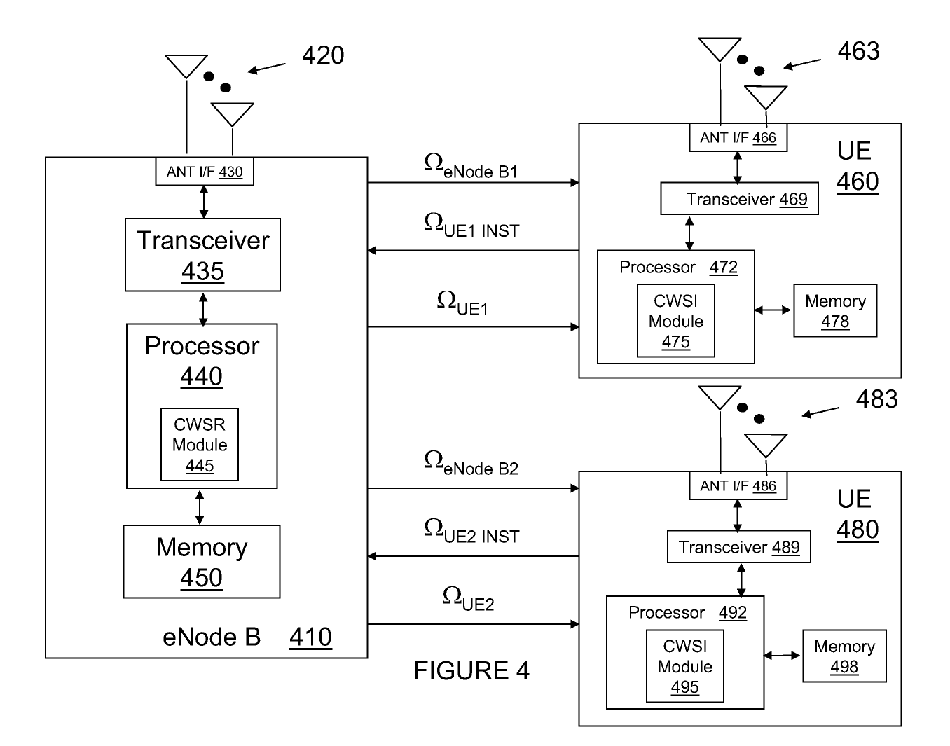

Turning now to FIG. 4, illustrated is a block diagram of an embodiment of a communication system employable with a MIMO communication network constructed according to the principles of the present invention. A base station or an eNode B 410 includes an antenna array 420 accessible through an antenna interface (“ANT I/F”) 430, a transceiver 435, a processor 440, and a memory 450 with code words embodied in a codebook. The codebook contains the set of all code words designed for the MIMO communication network. In establishing communication with first and second UEs 460, 480, a code word subset restriction (“CWSR”) module 445 operated in accordance with the processor 440 generates an eNode B code word subset Ω_{Node B1} based on the capabilities of the eNode B 410, the physical antenna array geometry, and the first UE 460. The eNode B 410 (via the transceiver 435, antenna interface 430 and antenna array 420) transmits the eNode B code word subset Ω_{eNode B1} to the first UE 460.

In response to the eNode B code word subset Ω_{eNode B1}, the first UE 460, which includes an antenna array 463, an antenna interface (“ANT I/F”) 466, a transceiver 469, a processor 472 (with a code word subset instruction (“CWSI”) module 475) and memory 478, determines a need to further restrict the eNode B code word subset Ω_{eNode B1} according to its own baseband computational capabilities. The code word subset instruction module 475 in accordance with the processor 472 generates and the first UE 460 (via the transceiver 469, antenna interface 466 and antenna array 463) transmits a higher layer signal of its own to the eNode B 410 with a UE-specific code word subset instruction Ω_{UE1 INST} for further restricting the eNode B code word subset Ω_{eNode B1}. The UE-specific code word subset instruction Ω_{UE1 INST} is provided in accordance with UE-specific computational capabilities of the first UE 460. Using the UE-specific code word subset instructions Ω_{UE1 INST}, the code word subset restriction module 445 generates a UE-specific code word subset Ω_{UE1} and the eNode B 410 transmits the same to the first UE 460 for final application. The processor 440 in conjunction with the transceiver 435 is configured to precode user data for transmission to the first UE 460 via the antenna array 420 with the UE-specific code word subset Ω_{UE1}. The first UE 460, which receives the user data via the antenna array 463, is configured to decode the user data (in accordance with the processor 472) employing the UE-specific code word subset Ω_{UE1}, thereby more efficiently communicating the user data between the eNode B 410 and the first UE 460.

It should be noted that the communications between the UEs and eNode Bs of the various embodiments of the present invention may be implemented over any appropriate signaling protocol, from lower physical (“PHY”) layer and media access control (“MAC”) layer signaling to higher layer signaling, such as radio resource control (“RRC”) signaling, and the like. The various embodiments of the present invention are not limited to any specific communication or signaling scheme. Also, the UEs and eNode Bs employ the respective subsystems and modules such as the transceivers, antenna interfaces and antenna arrays to perform the intended communications therebetween.

Since the restricted subsets may be generated independently based, at least in part, on the particular UE, the code word subset restriction module 445 generates an eNode B code word subset Ω_{eNode B2} and transmits the same (via the transceiver 435, antenna interface 430 and antenna array 420) to the second UE 480. In response thereto, the second UE 480, which includes an antenna array 483, an antenna interface (“ANT I/F”) 486, a transceiver 489, a processor 492 (with a code word subset instruction (“CWSI”) module 495) and memory 498, determines a need to further restrict the eNode B code word subset Ω_{eNode B2} according to its own baseband computational capabilities. The code word subset instruction module 495 in accordance with the processor 492 generates and the second UE 480 (via the transceiver 489, antenna interface 486 and antenna array 483) transmits a higher layer signal of its own to the eNode B 410 with a UE-specific code word subset instruction Ω_{UE2 INST} for further restricting the eNode B code word subset Ω_{eNode B2}. The UE-specific code word subset instruction Ω_{UE2 INST} is provided in accordance with UE-specific computational capabilities of the second UE 480. Using the UE-specific code word subset instruction Ω_{UE2 INST}, the code word subset restriction module 445 generates a UE-specific code word subset Q_{uE}2 and the eNode B 410 transmits the same to the second UE 480 for final application. The processor 440 in conjunction with the transceiver 435 is configured to precode user data for transmission to the second UE 480 via the antenna array 420 with the UE-specific code word subset Ω_{UE2}. The second UE 480, which receives the user data via the antenna array 483, is configured to decode the user data (in accordance with the processor 492) employing the UE-specific code word subset Ω_{UE2}, thereby more efficiently communicating the user data between the eNode B 410 and the second UE 480.

The code words and subsets thereof may be stored in the respective memories of the communication elements of the communication system. It should be noted that the UE-specific code word subsets Ω_{UE1}, Ω_{UE2} may contain different code words, depending on the capabilities of the first and second UEs 460, 480, respectively. Moreover, the UE-specific code word subset instructions Ω_{UE2 INST}, Ω_{UE2 INST} may take various forms, such as the number of codebook sizes each UE uses, exact codebook entries, or the like.

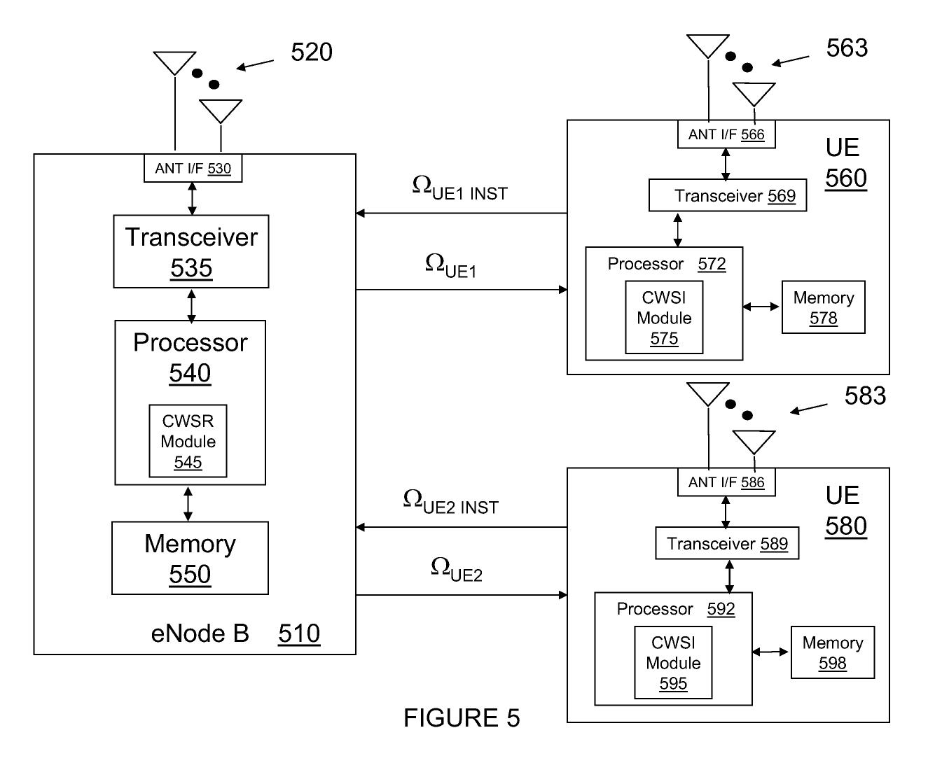

Turning now to FIG. 5, illustrated is a block diagram of an embodiment of a communication system employable with a MIMO communication network constructed according to the principles of the present invention. A base station or an eNode B 510 includes an antenna array 520 accessible through an antenna interface (“ANT I/F”) 530, a transceiver 535, a processor 540 (with a code word subset restriction (“CWSR”) module 545), and a memory 550 with code words embodied in a codebook. The codebook contains the set of all code words designed for the MIMO communication network. The eNode B 510 communicates with first and second UEs 560, 580. The first UE 560 includes an antenna array 563, an antenna interface (“ANT I/F”) 566, a transceiver 569, a processor 572 (with a code word subset instruction (“CWSI”) module 575) and memory 578. The second UE 580, includes an antenna array 583, an antenna interface (“ANT I/F”) 586, a transceiver 589, a processor 592 (with a code word subset instruction (“CWSI”) module 595) and memory 598.

In establishing communication between the first UE 560 and the eNode B 510. the code word subset instruction module 575 in accordance with the processor 572 generates and the first UE 560 (via the transceiver 569, antenna interface 566 and antenna array 563) transmits a signal to the eNode B 510 with a UE-specific code word subset instruction Ω_{UE1 INST}. The UE-specific code word subset instruction Ω_{UE1 INST} restricts the codebook to a code word subset compatible with the first UE 560. The UE-specific code word subset instruction Ω_{UE1 INST} is provided in accordance with UE-specific computational capabilities of the first UE 560. Using the UE-specific code word subset instruction Ω_{UE1 INST}, the code word subset restriction module 545 generates a UE-specific code word subset Ω_{UE1} and the eNode B 510 transmits the same to the first UE 560 for final application. The processor 540 in conjunction with the transceiver 535 is configured to precode user data for transmission to the first UE 560 via the antenna array 520 with the UE-specific code word subset Ω_{UE1}. The first UE 560, which receives the user data via the antenna array 563, is configured to decode the user data (in accordance with the processor 572) employing the UE-specific code word subset Ω_{UE1}, thereby more efficiently communicating the user data between the eNode B 510 and the first UE 560.

In establishing communication between the second UE 580 and the eNode B 510. the code word subset instruction module 595 in accordance with the processor 592 generates and the second UE 580 (via the transceiver 589, antenna interface 586 and antenna array 583) transmits a signal to the eNode B 510 with a UE-specific code word subset instruction Ω_{UE2 INST}. The UE-specific code word subset instruction Ω_{UE2 INST} restricts the codebook to a code word subset compatible with the second UE 580. The UE-specific code word subset instruction Ω_{UE2 INST} is provided in accordance with UE-specific computational capabilities of the second UE 580. Using the UE-specific code word subset instruction Ω_{UE2 INST}, the code word subset restriction module 545 generates a UE-specific code word subset Ω_{UE2} and the eNode B 510 transmits the same to the second UE 580 for final application. The processor 540 in conjunction with the transceiver 535 is configured to precode user data for transmission to the second UE 580 via the antenna array 420 with the UE-specific code word subset Ω_{UE2}. The second UE 580, which receives the user data via the antenna array 583, is configured to decode the user data (in accordance with the processor 592) employing the UE-specific code word subset Ω_{UE2}, thereby more efficiently communicating the user data between the eNode B 510 and the second UE 580.

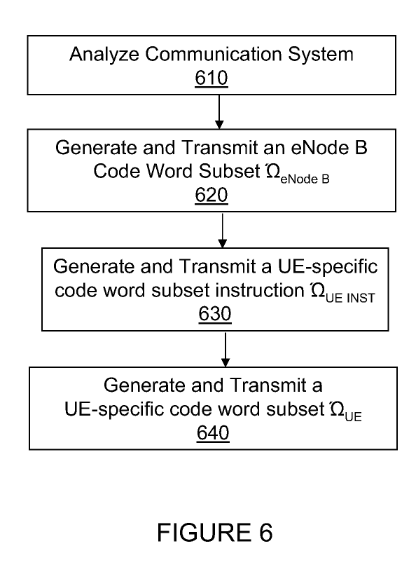

Turning now to FIG. 6, illustrated is a flowchart demonstrating an exemplary method of operating a communication system in accordance with the principles of the present invention. The capabilities of an eNode B and a UE, the physical antenna array geometry, and the like are analyzed in a step 610. Thereafter, a subset of code words is restricted from a plurality of code words. In accordance therewith, an eNode B code word subset Ω_{eNode B} is generated and transmitted during a step 620. The eNode B code word subset Ω_{eNode B} may be transmitted to a UE over a signaling protocol in accordance with a PHY and MAC layer signaling or higher layer signaling in accordance with an RRC. The UE generates and transmits a UE-specific code word subset instruction Ω_{UE INST}, in a step 630, indicating a further restricted code word subset designed for the UE's capabilities including, without limitation, a list of specific code words, a number of supportable code words, or the like. Based on the UE-specific code word subset instruction Ω_{UE INsT}, a UE-specific code word subset Ω_{UE} is generated and transmitted to the UE at a step 640. One skilled in the art should understand that selected steps may be added or omitted from the aforementioned method of operating the communication system and still fall within the broad scope of the present invention. For instance, the generation and transmission of an eNode B code word subset Ω_{eNode B} in accordance with step 620 may be omitted from the method introduced above.

Thus, representative embodiments of the present invention are directed to methods for precoding subset restrictions in a communication system. The method includes receiving a signal from one or more UEs requesting a restricted compatible code word subset compatible with the one or more UEs. In response to this signal (including a UE-specific code word subset instruction), an eNode B generates a UE-specific code word subset containing the code word subset defined by the signal. The eNode B then transmits the UE-specific code word subset to one or more UEs. In addition, the eNode B first generates a restricted subset of code words (e.g., an eNode B code word subset) wherein the restricted subset of codes is based at least in part on the eNode B capabilities, the physical antenna array geometry, and/or the UE. The eNode B then transmits the eNode B code word subset to one or more of the UEs. Also, the UE transmits the UE-specific code word subset instruction in response to receiving the eNode B code word subset. Additionally, the UE-specific code word subset instruction transmitted by the UE includes either a list of compatible code words to include in the UE-specific code word subset or a number of code words that the UE can support. In addition, the aforementioned signals are transmitted using a higher layer signaling protocol.

In accordance with another embodiment of the present invention, a UE is provided for a communication system. The UE includes a processor, code word subset instruction module and memory. A set of code words or a codebook is stored in the memory that includes the code words compatible with the UE. The UE includes an antenna array with transceiver(s) to transmit instructions to an eNode B and receive a UE-specific code word subset from an eNode B. The UE-specific code word subset from the eNode B is based on the code limits provided by the code word subset instruction module of the UE.

In accordance with another embodiment of the present invention, an eNode B is provided for a communication system. The eNode B includes a processor, code word subset restriction module and memory. A codebook of each of the code words approved for a communication network is maintained in the memory. The eNode B includes an interface with an antenna array that transmits subsets of the codebook (e.g., an eNode B code word subset) compiled by the code word subset restriction module and receives UE-specific code word subset instructions from one or more UEs in communication with the eNode B. The antenna transmits updated subsets (e.g., a UE-specific code word subset) from the codebook to the UE based on the subset modification instructions.

The program or code segments making up the various embodiments of the present invention may be stored in a computer readable medium or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a ROM, a flash memory, an erasable ROM (“EROM”), a floppy diskette, a compact disk CD-ROM, an optical disk, a hard disk, a fiber optic medium, a radio frequency (“RF”) link, and the like. The computer data signal may include any signal that can propagate over a transmission medium such as electronic network channels, optical fibers, air, electromagnetic links, RF links, and the like. The code segments may be downloaded via computer networks such as the Internet, Intranet, and the like.

As described above, the exemplary embodiment provides both a method and corresponding apparatus consisting of various modules providing functionality for performing the steps of the method. The modules may be implemented as hardware (including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. An apparatus, comprising:
a transceiver configured to receive a user equipment-specific code word subset instruction compatible with a user equipment; and
a processor including a code word subset restriction module configured to generate a user equipment-specific code word subset as a function of said user equipment-specific code word subset instruction for transmission to said user equipment, said processor being further configured to precode user data for transmission to said user equipment with said user equipment-specific code word subset.

2-30. (canceled)

31. The apparatus as recited in claim 1, wherein said code word subset restriction module is further configured to generate an apparatus code word subset from a codebook containing a set of all code words designed for a communication network for transmission to said user equipment.

32. The apparatus as recited in claim 1, wherein said code word subset restriction module is further configured to generate an apparatus code word subset from a codebook containing a set of all code words designed for a multiple-input, multiple-output communication network for transmission to said user equipment.

33. The apparatus as recited in claim 1, wherein said code word subset restriction module is further configured to generate an apparatus code word subset from a codebook containing a set of all code words designed for a communication network for transmission to said user equipment, said code word subset restriction module being configured to restrict said apparatus code word subset as a function of said user equipment-specific code word subset instruction to generate said user equipment-specific code word subset.

34. A method, comprising:
receiving a user equipment-specific code word subset instruction compatible with a user equipment;
generating a user equipment-specific code word subset as a function of said user equipment-specific code word subset instruction for transmission to said user equipment; and
precoding user data for transmission to said user equipment with said user equipment-specific code word subset.

35. The method as recited in claim 34, further comprising generating an apparatus code word subset from a codebook containing a set of all code words designed for a communication network for transmission to said user equipment.

36. The method as recited in claim 34, further comprising:
generating an apparatus code word subset from a codebook containing a set of all code words designed for a communication network for transmission to said user equipment; and
restricting said apparatus code word subset as a function of said user equipment-specific code word subset instruction to generate said user equipment-specific code word subset.

37. An apparatus, comprising:
a processor including a code word subset instruction module configured to generate an apparatus-specific code word subset instruction compatible with said apparatus; and
a transceiver configured to transmit said apparatus-specific code word subset instruction to a base station, said transceiver being configured to receive an apparatus-specific code word subset as a function of said apparatus-specific code word subset instruction and user data precoded with said apparatus-specific code word subset from said base station, said processor being further configured to decode said user data with said apparatus-specific code word subset.

38. The apparatus as recited in claim 37, wherein said code word subset instruction module is configured to generate said apparatus-specific code word subset instruction from a codebook containing a set of all code words designed for a communication network.

39. The apparatus as recited in claim 37, wherein said code word subset instruction module is configured to generate said apparatus-specific code word subset instruction from a codebook containing a set of all code words designed for a multiple-input, multiple-output communication network.

40. The apparatus as recited in claim 37, wherein said transceiver is further configured to receive a base station code word subset from a codebook containing a set of all code words designed for a communication network, said code word subset instruction module being configured to restrict said base station code word subset to generate said apparatus-specific code word subset instruction.

41. The apparatus as recited in claim 37, further comprising memory configured to store said apparatus-specific code word subset instruction and said apparatus-specific code word subset.

42. The apparatus as recited in claim 37, wherein said apparatus is a user equipment that forms part of a communication system with said base station.

43. A method, comprising:
generating an apparatus-specific code word subset instruction compatible with said apparatus;
transmitting said apparatus-specific code word subset instruction to a base station;
receiving an apparatus-specific code word subset as a function of said apparatus-specific code word subset instruction and user data precoded with said apparatus-specific code word subset from said base station; and
decoding said user data with said apparatus-specific code word subset.

44. The method as recited in claim 43, wherein said apparatus-specific code word subset instruction is generated from a codebook containing a set of all code words designed for a communication network.

45. The method as recited in claim 43, wherein said apparatus-specific code word subset instruction is generated from a codebook containing a set of all code words designed for a multiple-input, multiple-output communication network.

46. The method as recited in claim 43, further comprising:
receiving a base station code word subset from a codebook containing a set of all code words designed for a communication network; and
restricting said base station code word subset to generate said apparatus-specific code word subset instruction.

47. The method as recited in claim 43, further comprising storing said apparatus-specific code word subset instruction and said apparatus-specific code word subset.

48. A computer program product comprising a computer-readable medium bearing computer program code embodied therein for use with a computer, the computer program code comprising:
code for generating an apparatus-specific code word subset instruction compatible with said apparatus;
code for transmitting said apparatus-specific code word subset instruction to a base station;
code for receiving an apparatus-specific code word subset as a function of said apparatus-specific code word subset instruction and user data precoded with said apparatus-specific code word subset from said base station; and
code for decoding said user data with said apparatus-specific code word subset.

49. The computer program product as recited in claim 48, further comprising
code for receiving a base station code word subset from a codebook containing a set of all code words designed for a communication network; and
code for restricting said base station code word subset to generate said apparatus-specific code word subset instruction.
